(19) United States
(12) Patent Application Publication
(10) Pub. No.: US 2012/0191982 A1
(43) Pub. Date: Jul. 26, 2012

(54) NON-VOLATILE STORAGE OF ENCRYPTED DATA

(76) Inventor: Timothy Evert LEVIN, Pacific Grove, CA (US)

(21) Appl. No.: 12/329,453

(22) Filed: Dec. 5, 2008

Related U.S. Application Data
(60) Provisional application No. 61/008,157, filed on Dec. 6, 2007.

(51) Int. Cl. G06F 12/14; G06F 12/08

(52) U.S. Cl. 713/189; 711/118; 711/E12.092; 711/E12.017

(57) ABSTRACT

Embodiments in accordance with the invention utilize the cryptographic transformation function of an SP processor to encrypt data at rest. The use of the primary processor-based cryptographic transformation function is preferable to use of an auxiliary cryptographic processor because the transformation occurs directly, and thus can be faster and more cost effective.

### CROSS REFERENCE TO RELATED APPLICATION

This application claims the benefit of U.S. Provisional Application No. 61/008,157, filed Dec. 6, 2007 which is hereby incorporated in its entirety by reference.

### BACKGROUND OF THE INVENTION

1. Field of the Invention

Embodiments in accordance with the invention relate to encryption of data.

2. Description of the Related Art

Data exists in computer environments in primarily three states: at rest, in process, and in movement. When at rest, the data is typically in a memory storage medium that is persistent, e.g., a hard disk, meaning that the data is preserved, even if the power to the storage medium is turned off, the representation and value of the data is the same when the power is again turned on. In contrast, a volatile memory medium the data loses its value when the power is turned off.

Data at rest often needs to be encrypted. The encryption transformation can be achieved through a software- or hardware-instantiated algorithm. The latter is preferable because direct hardware transformation can be faster.

General purpose processors generally do not include cryptographic transformation algorithms, accordingly such hardware-based cryptographic transformations are usually performed by an auxiliary processor, indirectly, at the request of a primary general purpose processor. An SP processor, sometimes referred to as a “secret protected” processor, is a primary general purpose processor that includes a cryptographic transformation function for encrypting data while the data is in process, for the purpose of protecting intermediate processing results from being viewed or modified while the data is in a cache memory or main memory module, which are volatile. However, results of the cryptographic transformation function do not protect data at rest.

### SUMMARY OF THE INVENTION

Embodiments in accordance with the invention utilize the cryptographic transformation function of an primary processor, such as an SP processor, to encrypt data at rest. The use of the primary processor-based cryptographic transformation function is preferable to use of an auxiliary cryptographic processor because: (1) the transformation occurs directly, and thus can be faster; and (2) the transformation obviates the need for an additional auxiliary component, and thus it can be cheaper to manufacture.

In accordance with one embodiment, a method for non-volatile storage of SP processor-encrypted data includes: moving data into a cache memory; marking the data in the cache memory for encryption; encrypting the data to form encrypted data and moving the encrypted data from the cache memory to a main memory; and moving the encrypted data from the main memory to a non-volatile storage medium, such a disk, such that the encrypted data is stored in the non-volatile storage medium.

In accordance with another embodiment, a method for retrieving SP-encrypted data from a non-volatile storage medium includes: moving encrypted data from a non-volatile storage medium to a main memory; decrypting the encrypted data to form decrypted data and moving the decrypted data from the main memory to a cache memory.

In accordance with another embodiment, a computer system includes: a computer processor, a cache memory, a main memory, a transformation function layer, an application for non-volatile storage of SP-encrypted data, and a non-volatile storage medium, wherein execution of the application by the computer processor results in a method including: moving data into a cache memory; marking the data in the cache memory for encryption; moving the data from the cache memory to a main memory utilizing a processor mechanism that automatically encrypts data so marked to form encrypted data, such that the data is stored as encrypted data in the main memory; and moving the encrypted data to a non-volatile storage medium, such as a disk, such that the encrypted data is stored in the non-volatile storage medium. In some embodiments, execution of the application by the computer processor further results in moving the encrypted data from the non-volatile storage medium to a main memory; and moving the encrypted data from the main memory to a cache memory and decrypting the data to form decrypted data, such that the decrypted data is stored in the cache memory, where the decrypted data can be processed in a conventional, e.g., normal, fashion for unencrypted data.

Embodiments in accordance with the invention are best understood by reference to the following detailed description when read in conjunction with the accompanying drawings.

### BRIEF DESCRIPTION OF THE DRAWINGS

FIG. 1 is a process flow diagram of a method for non-volatile storage of SP-encrypted data in accordance with one embodiment.

FIG. 2 is a process flow diagram of a method for retrieving SP-encrypted data from non-volatile in accordance with one embodiment.

FIGS. 3A-3E are block diagrams of a computer system including the method of FIG. 1 and illustrating execution of the method of FIG. 1 in accordance with one embodiment.

Common reference numerals are used throughout the drawings and detailed description to indicate like elements.

### DETAILED DESCRIPTION

As earlier described, an SP processor is a primary general purpose processor which includes a cryptographic transformation function for encrypting data while the data is in process, for the purpose of protecting intermediate processing results from being viewed or modified while the data is in a cache memory or main memory module, which are volatile. However, results of the transformation function do not protect data at rest.

Code in execution by a primary processor is called a process. In an SP processor, processes can be in one of two states: concealed execution mode (CEM) and normal. In order to encrypt data utilizing an SP processor, the process must be in CEM. It is desirable for security purposes for the same code module that stores the data on the disk to also be in CEM, otherwise the encryption and storage operations would be in different modules, introducing unwanted complexity. When a CEM process reads the encrypted data into the processor for the purpose of writing the data to the disk, the data is automatically decrypted, and the data is written to the disk in decrypted form.

Herein embodiments in accordance with the invention are described with reference to an SP processor. Those of skill in the art can recognize, however, that the embodiments described herein are also applicable to other primary processors including a cryptographic transformation function. Further herein examples of pseudo-code are provided to more clearly describe the invention. Further, for clarity of description, the module in which a function or instruction resides is indicated in the pseudo-code by the prefix to the function name. For example, “sp_” indicates SP processor specific instructions; “hw_” indicates generic general purpose instructions; and “tml_” indicates trusted management layer instructions.

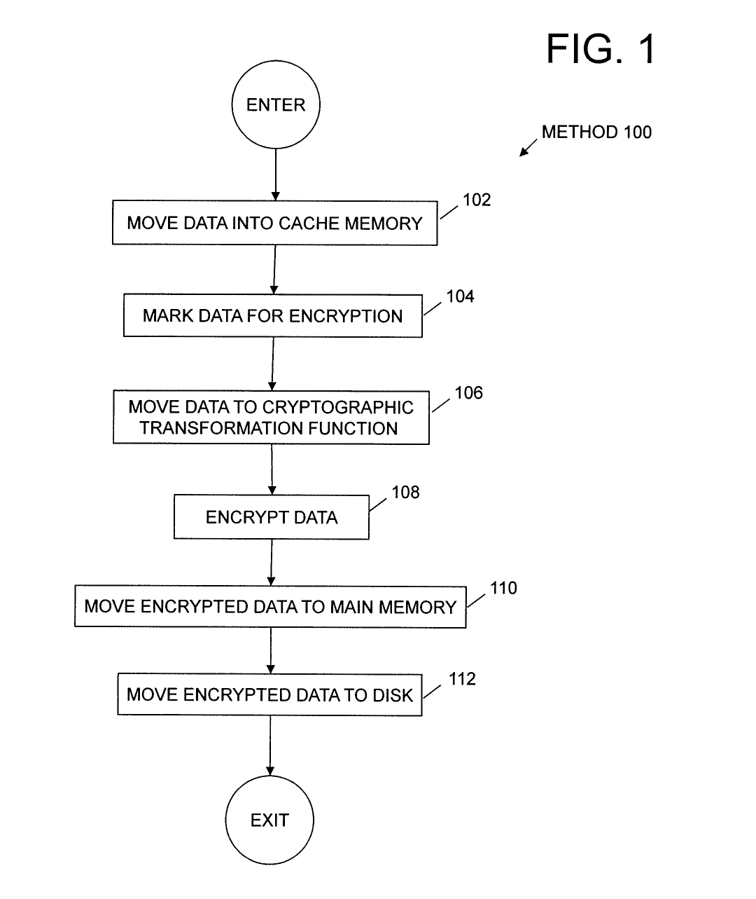

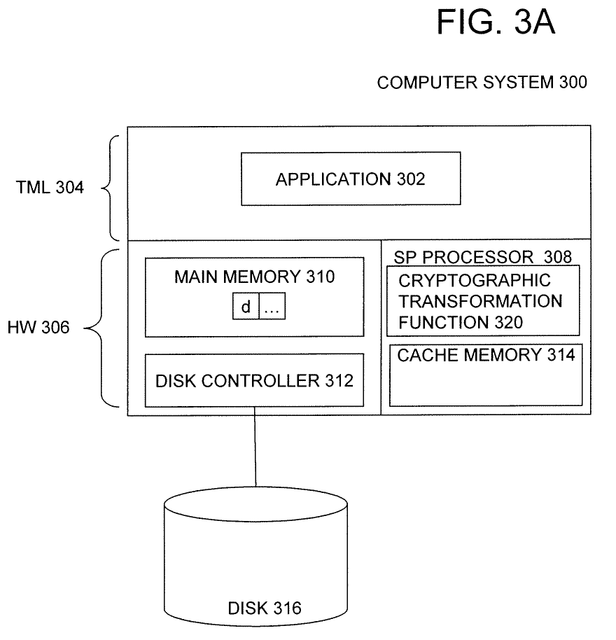

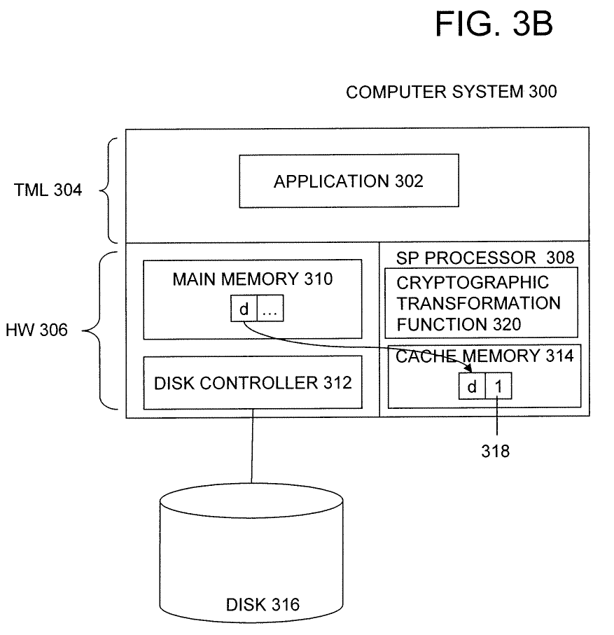

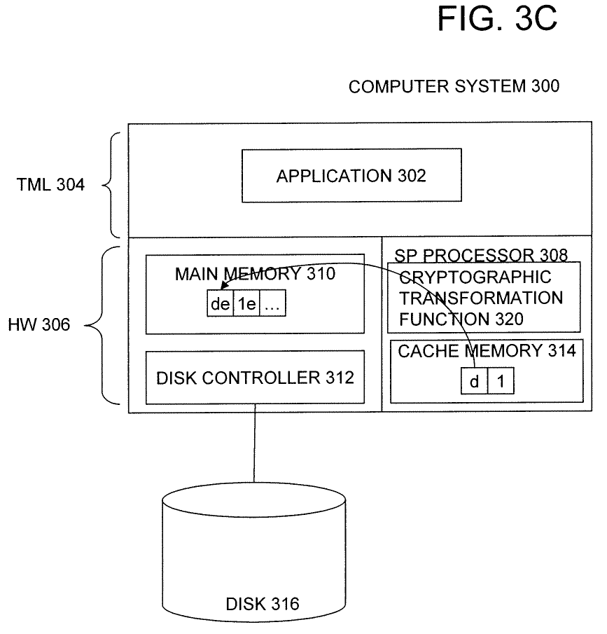

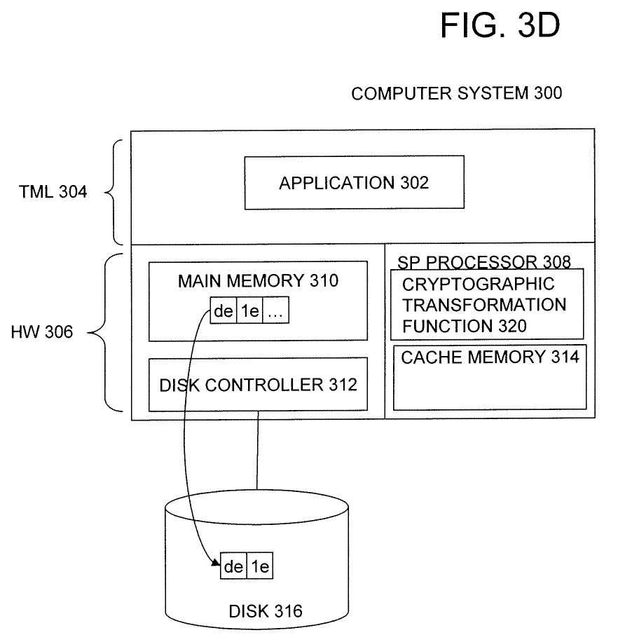

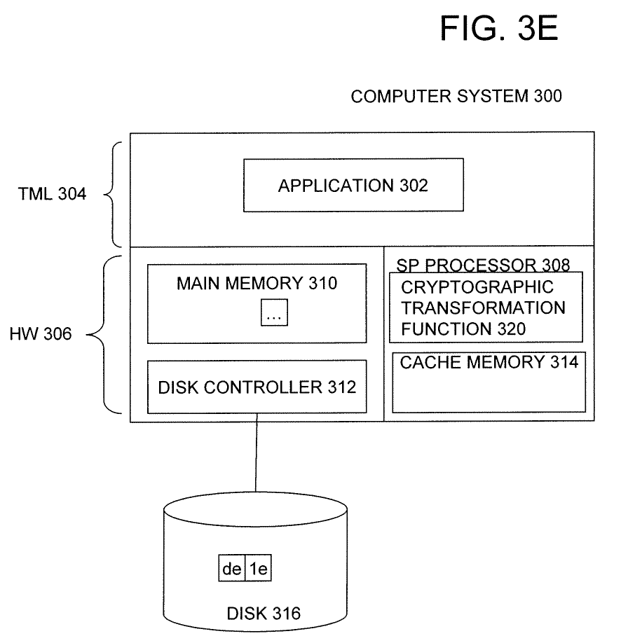

Referring now more particularly to FIG. 1, FIG. 1 illustrates a method 100 for non-volatile storage of SP-encrypted data in accordance with one embodiment. Method 100 is described herein with reference to FIGS. 3A-3E. FIGS. 3A-3E are block diagrams of a computer system illustrating execution of method 100 in accordance with one embodiment. Herein the alphabetic suffixes A-E in FIGS. 3A-3E are utilized to more clearly illustrate execution progression of method 100 in computer system 300.

Referring initially to FIG. 3A, in one embodiment, computer system 300 includes an operating system (not shown) having software that is responsible for managing and protecting data in memory and on disk. This software, sometimes referred to as a “security kernel,” is herein referenced as the trusted management layer (TML) 304.

Computer system 300 further has a hardware layer 306 including an SP processor 308, main memory 310, and disk controller 312. In one embodiment, SP processor 308 includes a cryptographic transformation function 320 and a cache memory 314. In one embodiment computer system 300 includes or is communicatively connected to a non-volatile storage medium, such as disk 316, e.g., one or more hard disk drives. In various embodiments, computer system 300 can further include various input and output devices, such as monitor, keyboard, mouse, and one or more I/O devices or ports (not shown).

In one embodiment, method 100 is implemented as application 302 supported by TML 304 and executed by SP processor 308 of computer system 300. In one embodiment application 318 is a stand alone application accessible by the operating system or TML 304 or is included as part of the operating system or TML 304, and is executable by SP processor 308.

Referring now to FIGS. 1 and 3A together, in one embodiment, data results from a process implemented on computer system 300 is present in a main memory 310 and application 302 is called and executed by SP processor 308 with operation 102 being entered.

Referring now to FIGS. 1 and 3B together, in one embodiment, in operation 102, selected data d is moved from main memory 310 into a cache memory 314. For example, in one embodiment, the instruction hw_move is used to move selected data d from main memory 310 to cache memory 314. From operation 102, processing proceeds to operation 104.

In operation 104, the selected data d now in cache memory 314 is marked for encryption. For example, in one embodiment, the instruction sp_secure_store is used to mark selected data d for encryption using a secure data tag. For example, in one embodiment, secure data tag 318, illustrated in FIG. 3B as “1” is used for marking data d for encryption. Those of skill in the art can understand that in other embodiments other secure data tag methodologies can be used to indicate data selected for encryption. From operation 104 processing proceeds to operation 106.

Referring now to FIGS. 1 and 3C, in one embodiment, in operation 106 the selected data d marked for encryption in cache memory 314, is moved from cache memory 314, encrypted via cryptographic transformation function 320 and moved to main memory 310. For example, in one embodiment, the instruction hw_clflush is used to encrypt data d in cache memory 314 to form encrypted data de and to move the encrypted data de from cache memory 314 to main memory 310. In one embodiment, the secure data tag 318, e.g., “1”, is also encrypted to form encrypted secure data tag “1e” and moved from cache memory 314 to main memory 310. Accordingly, the encrypted form of the data de has now replaced the initial data d in main memory 310, e.g., de has replaced d in main memory 310. From operation 106, processing proceeds to operation 108.

Referring now to FIGS. 1 and 3D, in one embodiment, in operation 108 the encrypted data de and encrypted secure data tag 1e in main memory 310 are moved to a non-volatile storage medium, such as disk 316. For example, in one embodiment, the instruction dma_device_write is used to move the encrypted data de from main memory 310 to disk 316. From operation 108 processing exits method 100.

The following is one embodiment of pseudo code illustrating the operations of method 100. To encrypt a memory segment of disk, i.e., data stored in a memory segment of main memory 310, TML 304 first calls tml_mark_segment with the handle, e.g., name, of the memory segment. The instruction tml_mark_segment marks the memory segment for encryption. TML 304 then calls tml_flush2disk to both encrypt the segment and write the encrypted segment to disk, for example:
tml_mark_segment(user_seg: eval_seg_handle)
tml_flush2disk(user_seg: eval_seg_handle).

The instruction tml_mark_segment initially ensures that all of the cache lines, e.g., subsets of a memory segment in volatile memory, of the memory segment are marked for encryption by calling tml_mark_line; for example:
tml_mark_segment(user_seg: eval_seg_handle)=(for i=1 . . . Length(user_seg) do

if not user_seg.i.SecureData then//secure data tag bit
tml_mark_line(user_seg.i, user_seg, i).

The instruction tml_mark_line is handed a word of data and a memory destination (segment and offset):
tml_mark_line(w: word, dest_seg: ivol_seg_handle, offset: word)=(hw_move (R2, w)
tml_cem_secure_store(dest seg, offset R2)).
   The instruction hw_move moves the word from main memory 310 into a general-purpose register, pulling the word into cache memory 314.

The internal procedure tml_cem_secure_store calls sp_secure_store to mark the cache line for encryption:
tml_cem_secure_store(dest seg, offset, R2)=sp_secure_store (dest_seg, offset,R2))
   The instruction tml_flush2disk uses hw_clflush to push to memory the elements of the segment that are in processor cache 314, which cause SP processor 308 to encrypt them and then writes the entire segment to the disk:
tml_flush2disk(user_seg)=(for i=1 . . . Length (user_seg_do
hw_clflush (i)//flush all cache lines of segment dma_device_write(user_seg)).

As the tml_flush2disk and tml_mark_segment operations are both called in CEM, for security reasons, a DMA disk device must be used to copy the encrypted segment directly from memory onto the disk, called DMA I/O, because using the processor to write to disk, called programmed I/O, would cause the memory to be decrypted first, i.e., by pulling it back in to the processor in order to write to the disk. Thus, in accordance with method 100 SP processor 308 is used to encrypt data and store the encrypted data in a non-volatile storage medium, such as disk 316.

In a further embodiment, application 318 also includes a method 200 for retrieving and decrypting encrypted data stored in a non-volatile storage medium, such as disk 316. In one embodiment, method 200 can be implemented separate from method 100, or in other embodiments, method 200 can be implemented as additional operations to method 100. In the latter embodiment, for example, following operation 108 alternatively method 200 can be entered upon receipt of a request for encrypted data stored on disk 316.

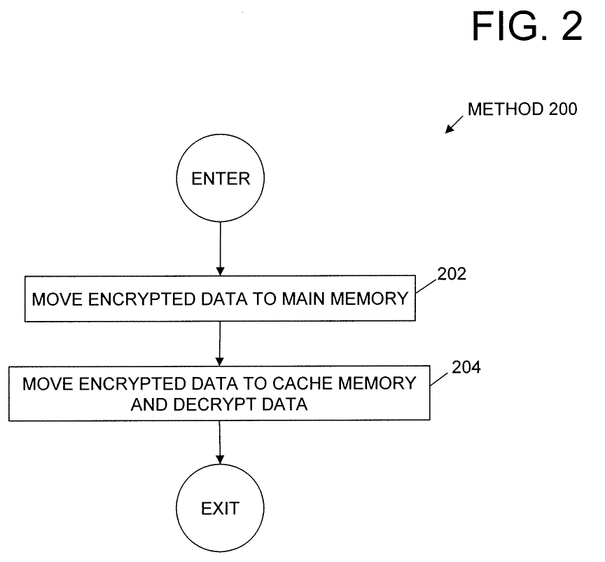

Referring now to FIG. 2 and method 200, in one embodiment, execution of application 302 by SP processor 308, for example, on receipt of a request for encrypted data stored on disk 316 results in method 200 being entered at operation 202.

In operation 202, in one embodiment, the encrypted data de is moved from the non-volatile storage medium to main memory 310. For example, in one embodiment, the instruction dma_device_read is used to move the encrypted data de from disk 316 to main memory 310, for example the reverse of FIG. 3D. From operation 202, processing proceeds to operation 204.

In operation 204, the encrypted data de in main memory 314 is moved into cache memory 314 and decrypted. For example, in one embodiment, the instruction sp_secure_load is used to move the data de and the secure data tag 318 from main memory 310, decrypt the data de in main memory 310 to form decrypted data d and to move the decrypted data d into cache memory 314, for example, the reverse of FIG. 3C.

In view of this disclosure, the functionalities of methods 100 and 200 and computer system 300 in accordance with the embodiments of the invention can be implemented in a wide varied of computer system configurations. This disclosure provides exemplary embodiments of the invention. The scope of the invention is not limited by these exemplary embodiments. Various embodiments, whether explicitly provided for by the specification or implied by the specification or not, may be implemented by one of skill in the art in view of this disclosure.

1. A method for non-volatile storage of primary processor encrypted data comprising:
moving data from a main memory of a computer system to a cache memory of a primary processor;
marking said data for encryption in said cache memory with a secure data tag;
moving said data with said secure data tag from said cache memory to a cryptographic transformation function of said primary processor, encrypting said data and said secure data tag by said cryptographic transformation function to form encrypted data and an encrypted secure data tag, and moving said encrypted data and said encrypted secure data tag to said main memory; and
moving said encrypted data and said encrypted secure data tag from said main memory to a non-volatile storage medium.

2. The method of claim 1 further comprising:
moving said encrypted data and said encrypted secure data tag from said non-volatile storage medium to said main memory; and
moving said encrypted data and said encrypted secure data tag from said main memory to said cryptographic transformation function, decrypting said encrypted data and said encrypted secure data tag to form decrypted data and a decrypted secure data tag, and moving said decrypted data to said cache memory.

3. The method of claim 1 wherein said primary processor is an secret-protected processor.

4. (canceled)

5. (canceled)

6. A computer system including:
a primary processor, said primary processor comprising:
a cryptographic transformation function, and
a cache memory;
an operating system, said operating system including a trusted management layer (TML);
a main memory;
a non-volatile storage medium; and
an application for non-volatile storage of secret-protected-encrypted data.

7. The computer system of claim 6, wherein execution of said application for non-volatile storage of said secret-protected-encrypted data causes said primary processor to execute a method comprising:
moving data from said main memory of said computer system to said cache memory of said primary processor;
marking said data for encryption in said cache memory with a secure data tag;
moving said data from said cache memory to said cryptographic transformation function of said primary processor, encrypting said data and said secure data tag by said cryptographic transformation function to form encrypted data and an encrypted secure data tag, and moving said encrypted data and said encrypted secure data tag to said main memory; and
moving said encrypted data and said encrypted secure data tag from said main memory to said non-volatile storage medium.

8. The computer system of claim 7, wherein the method further comprises:
moving said encrypted data and said encrypted secure data tag from said non-volatile storage medium to said main memory; and
moving said encrypted data and said encrypted secure data tag from said main memory to said cryptographic transformation function, decrypting said encrypted data and said encrypted secure data tag to form decrypted data and a decrypted secure data tag, and moving said decrypted data to said cache memory.

9. The computer system of claim 6 wherein said primary processor is a secret-protected (SP) processor.
